(19) United States
(12) Patent Application Publication
(10) Pub. No.: US 2015/0324849 A1
(43) Pub. Date: Nov. 12, 2015

(54) EMAIL SIGNATURE ADVERTISEMENT TARGETING

(71) Applicants: Mayur Datar, Santa Clara, CA (US); Ashutosh Garg, Sunnyvale, CA (US); Yifan Shi, Sunnyvale, CA (US); Hai Fang, Mountain View, CA (US)

(72) Inventors: Mayur Datar, Santa Clara, CA (US); Ashutosh Garg, Sunnyvale, CA (US); Yifan Shi, Sunnyvale, CA (US); Hai Fang, Mountain View, CA (US)

(21) Appl. No.: 12/035,241

(22) Filed: Feb. 21, 2008

(51) Int. Cl. G06Q 30/02; G06F 17/30; G06F 15/16; G06F 7/06

(52) U.S. Cl. CPC G06Q 30/0257; G06Q 30/0277

(57) ABSTRACT

Methods, systems, and computer program products are provided for information presentation. In one implementation, a method is provided. The method includes generating a message, identifying suggested content to be included with the message, suggesting one or more of the suggested content items to a user, receiving a user input with respect to the one or more suggested content items, and sending the message according to the user input including one or more selected content items of the one or more suggested content items.

### BACKGROUND

This specification relates to information presentation.

Advertisers provide advertisements in different forms in order to attract consumers. An advertisement (“ad”) is a piece of information designed to be used in whole or part by a user, for example, a particular consumer. For example, an advertisement can be printed and delivered to consumers through the mail or within a newspaper. Advertisements can also be provided in electronic form, for example, as a banner advertisement on a web page. The presentation of an advertisement to a consumer, or simply the inclusion of an advertisement in a media can be called an impression.

The advertisement may include an incentive (e.g., a coupon or other discount) to encourage the consumer to purchase a particular product or service. If the consumer purchases the advertised product or service in response to the advertisement, an event called a conversion can occur. A conversion is said to occur when a user consummates a transaction related to a previously served advertisement. What constitutes a conversion may vary from case to case and can be determined in a variety of ways. For example, a conversion may occur when a user clicks on an advertisement, is referred to the advertiser's web page, and consummates a purchase there before leaving that web page.

Conventional electronic mail (“email”) systems typically provide a signature block for email messages. The signature block is a region, typically at the bottom of an email message, that is included in each email message. Conventionally, the email system automatically adds the signature block to each new email message. Signature blocks can be used, for example, to provide contact information of a user, a personal quote, or other individualized content specified by a user.

### SUMMARY

Methods, systems, and computer program products are provided for information presentation. In general, in one aspect, a method is provided. The method includes generating a message, identifying suggested content to be included with the message, suggesting one or more of the suggested content items to a user, receiving a user input with respect to the one or more suggested content items, and sending the email message according to the user input including one or more selected content items of the one or more suggested content items. Other embodiments of this aspect include corresponding systems, apparatus, and computer program products.

The aspect can optionally include one or more of the following features. Identifying suggested content items can further include identifying advertisements according to one or more user specified parameters. The user specified parameters can include a designation of advertisements shown for free, specified keywords to be used for advertisement selection, or an identification of recipients to receive advertisements from the user. The specified parameters can include one or more filters and identifying suggested content items includes applying the one or more filters to a collection of advertisements. Identifying suggested content items can include using keywords of the message. Suggesting one or more of the suggested content items can include presenting one or more advertisements to the user. Receiving the user input can include receiving a selection of a particular advertisement of the selected content items or receiving an input to not include an advertisement with the message.

In general, in one aspect, a method is provided. The method includes receiving a request from a user for one or more content items to be included in an message, the one or more content items satisfying one or more parameters, identifying one or more content items according to the one or more parameters, and sending the one or more content items the user. Other embodiments of this aspect include corresponding systems, apparatus, and computer program products.

The aspect can optionally include one or more of the following features. Receiving a request can include receiving the one or more parameters. Receiving the one or more parameters can include receiving one or more keywords of the message. Identifying one or more content items can include sorting a collection of available advertisements according to the one or more parameters.

The aspect can further include tagging the one or more content items prior to sending the one or more content items to the user, identifying an event associated with particular content items, using the tag associated with the content items to identify the user, and crediting an account of the user. The event can be an impression or click event by a recipient of the message. The event can be a conversion event by a recipient of the message.

In general, in one aspect, a method is provided. The method includes receiving an input from a message system user to include content items in messages, present a collection of content items for selection according to user specified criteria, receive a selection of one or more selected content items from the collection, and serving the selected content items to the message system. Other embodiments of this aspect include corresponding systems, apparatus, and computer program products.

The aspect can optionally include one or more of the following features. The aspect can further include receiving a user input identifying one or more parameters to be used as criteria for presenting a collection of content items for selection. Receiving user input identifying one or more parameters can include a type of content item. The aspect can further include generating an account for the user, the account including information for content item revenue sharing.

In general, in one aspect, a method is provided. The method includes identifying one or more identified content items to suggest to a user, tagging the identified content items, the tag identifying the user associated with the content items, detecting an event corresponding to a particular content item of the one or more content items, using the tag associated with the particular content item to identify the user, and crediting the user according to the detected event. Other embodiments of this aspect include corresponding systems, apparatus, and computer program products.

The aspect can optionally include one or more of the following features. Tagging the identified content items can include adding data to each of the content items that uniquely identifies the user. The detected event can be an impression event, click event, or conversion event.

Particular embodiments of the subject matter described in this specification can be implemented to realize one or more of the following advantages. A user can control the content (e.g., advertising content) included in email signature blocks. The user can share revenue generated from advertisements included in the user's email signature block. Email signature advertisements can be targeted according to the user's knowledge or interests or according to the user's knowledge of the interests of the recipients. Users may be more responsive to email signature advertisements as compared to advertisements displayed in other locations, to which many users have developed an ad blindness.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example network system.

FIG. 2 is a block diagram of an example advertising system.

FIG. 3 is a block diagram of an example email system.

FIG. 4 shows an example method for sending advertisements with email messages.

FIG. 5 shows an example method for identifying one or more advertisements.

FIG. 6 is an example screenshot of an email composition display.

FIG. 7 shows an example method for identifying one or more advertisements.

FIG. 8 is an example screenshot of an email settings display.

FIG. 9 shows an example method for providing advertisements.

FIG. 10 shows an example method for providing advertisements to an email system.

FIG. 11 shows an example method for tracking email advertisements.

FIG. 12 is an example screenshot of a received email including an advertisement.

FIG. 13 is a schematic diagram of a generic computer system.

Like reference numbers and designations in the various drawings indicate like elements.

### DETAILED DESCRIPTION

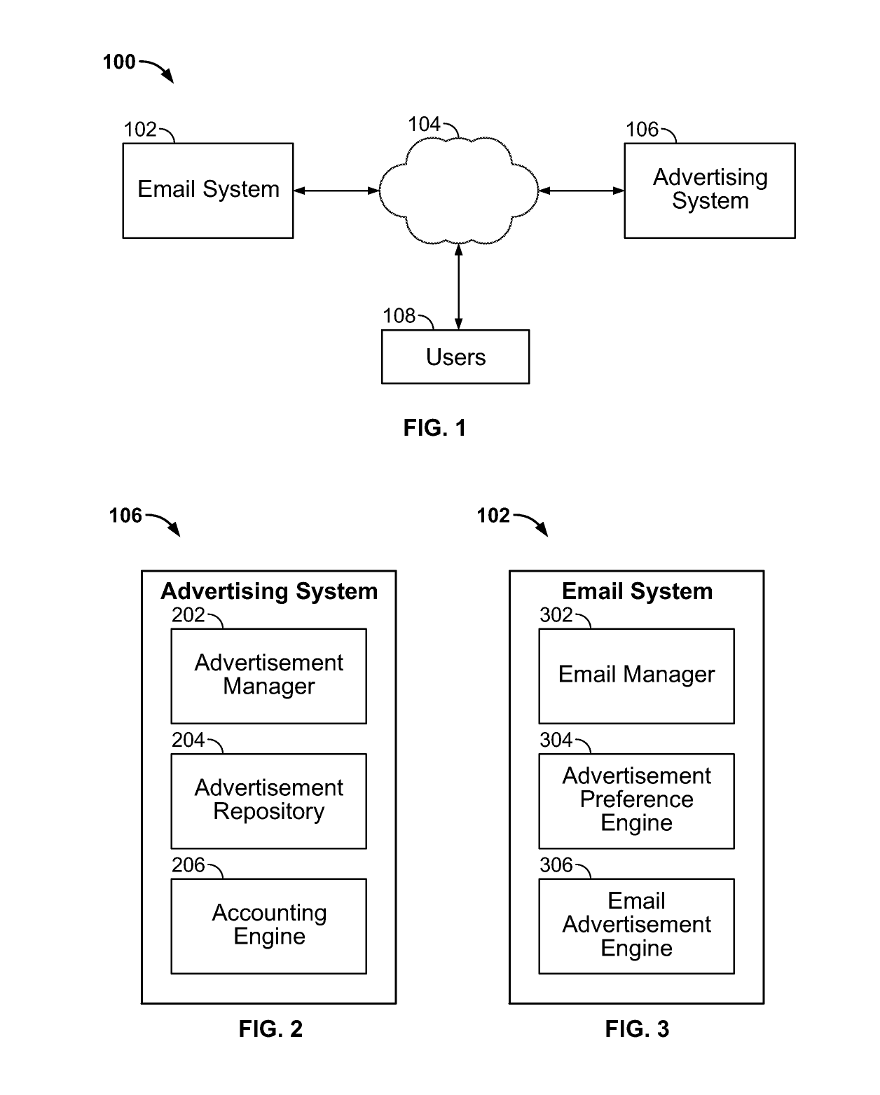

FIG. 1 is a block diagram of an example network system 100. The system 100 includes an email system 102 an advertising system 106, and users 108 that can communicate using a network 104. The email system 102 allows users 108 to send and receive messages. For example, the email system 102 can be a mail server that includes an interface allowing particular users to compose, send, and view email messages from one or more remote locations. Though reference is made to an email system, other messaging systems including other message formats can be used (e.g., SMS).

The users 108 can include a number of distinct users. Each user 108 can be a sender and/or a recipient of one or more email messages. In some implementations, the users 108 can access the email system 102 through the network 104 using a browser. Alternatively, in another implementation, particular users 108 can include a local email client that allows them to locally send and retrieve mail messages from the email system 102.

The advertising system 106 can provide advertisements to the email system 102, for example, for inclusion in email messages sent by individual users 108. The advertising system 106 can receive advertisements, for example, from one or more advertisers. The advertising system 106 can provide advertisements to the email system according to particular parameters or user specifications. Though reference is made to an advertisement system, other content delivery systems that provide other forms of content (e.g., other forms of sponsored content) can be used.

The network 104 can include one or more networks providing communication throughout the system 100. The one or more networks can include local area networks (“LAN's”), wide area networks (“WAN's”) as well as the Internet, or combinations of the two. In some implementations, the advertising system 106 and the email system 102 are located within a same local network. Alternatively, the advertising system 106 and the email system 102 can be integrated into a single system component.

FIG. 2 is a block diagram of an example advertising system 200. The advertising system 200 includes an advertisement manager 202, advertisement repository 204, and accounting engine 206. The advertisement repository 204 includes a collection of advertisements available for serving to various content providers including email systems. The advertisements 204 can be received, for example, from advertisers or other entities.

The advertisement manager 202 determines which advertisements to present to the content providers. In some implementations, an advertiser can provide particular criteria for presenting a particular advertisement. For example, an advertiser can provide geographic location and time of day requirements for the advertisement. The advertiser can also identify a payment structure for served advertisements. For example, in some implementations, the advertiser pays for each impression. In other implementations, the advertiser only pays for impressions that lead to a selection (e.g., a click) or conversion. Alternatively, the advertiser can pay a different amount depending on the type of event (e.g., less for an impression than a conversion).

Additionally, the advertiser can provide keywords or other information (e.g., categories, advertiser preferences, preferred keywords, local target demographics, etc.) associated with the advertisement that can be used by the advertisement manager 202 to target the advertisement. Alternatively, the advertisement manager 202 can receive keywords to associate with the advertisement from another source or generate the keywords according to the content of the advertisement and other information possessed by the advertisement manager 202.

The advertisement manager 202 can use the information provided by the advertiser as well as information provided by a content provider or other information in determining which advertisement to serve to the content provider. For example, content provider information can include context information associated with the request for an advertisement (e.g., keywords or search terms of a user associated with the content provider). The content provider information can also include advertisement parameters associated with an advertisement request including identifying particular advertisements or categories of advertisements to be served.

For example, a request for an advertisement can be received by the advertising system 200 from a particular content provider. The request can include parameters specifying that the advertisement should relate to automobiles. The advertisement manager 202 can identify one or more advertisements of advertisements 204 that relate to automobiles. The advertisement manager 202 can also determine which advertisements satisfy advertiser criteria (e.g., by location, time, etc.). The advertisement manager 202 can then rank all matching advertisements according to particular ranking criteria and serve one or more of the advertisement to the content provider using the request.

The account engine 206 manages accounts for advertisers, content providers, and other users. For example, the account engine 206 manages fees to be paid by the advertisers in exchange for events (e.g., impressions, clicks, or conversions) associated with served advertisements. Additionally, in some implementations, the account engine 206 manages user accounts for advertisement revenue sharing between the advertisements system 200 and users presenting the advertisements.

FIG. 3 is a block diagram of an example email system 300. The email system 300 includes an email manager 302, advertisement preference engine 304, and an email advertisement engine 306.

The email manager 302 manages email accounts for one or more users. For example a number of users (e.g., users 108) can have email accounts on the email system 300. Each individual user can be identified, for example, by a username and password. The email manager 302 can manage email functions for each user including, for example, generating new mail messages, sending composed mail messages, and storing received mail messages. In some implementations, the email manager 302 provides other features allowing the user to, for example, organize and search received mail messages.

The advertisement parameters 304 include, for example, user preferences for particular advertisements or types of advertisements to be included in email messages sent by the user. For example, the user parameters can include whether to include advertisements in outgoing messages and the type of advertisement to include. Parameters for including advertisements can include parameters for providing advertisements to particular contacts in an address book or no advertisements at all. Additionally, the type of advertisements can include an identification of whether to include advertisements directed to charitable organizations versus for profit companies.

In some implementations, the type of advertisement can also include a user specification of keywords, categories, or other filtering parameters for identifying particular categories of advertisements to include in outgoing mail messages. In other implementations, one of more specific advertisements can be specified by the user to be included in outgoing messages according to particular criteria.

The email advertisement engine 306 facilitates the request and receipt of advertisements, e.g., from the advertising system 200. For example, when a user composes a new mail message, the email advertisement engine 306 can request one or more advertisements from the advertising system 200. The email advertisement engine 306 presents received advertisements to the user and/or incorporates the received advertisements into one or more email messages.

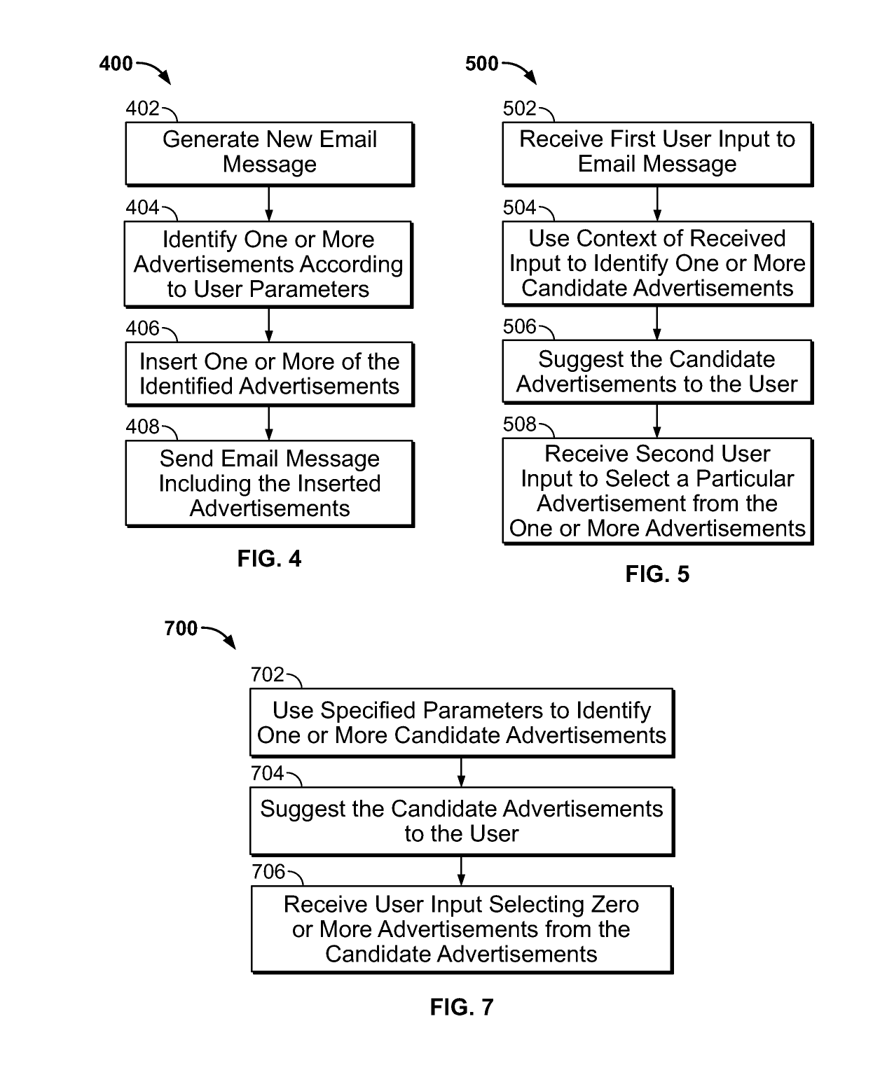

FIG. 4 shows of an example method 400 for sending advertisements with email messages. For convenience, the method 400 will be described with respect to a system (e.g., email system 102) that performs the method 400.

The system generates 402 an email message. A user, for example accessing the email system, provides an input to an email interface requesting a new message. For example, the user can select a “new message” button or link. Alternatively, the user can respond to a previously received message including generating a new message. Once a message has been generated, the system receives 404 message content. For example, the user can type text into a composition field of the new message, add a subject, identify one or more recipients, or attach files.

The system identifies 406 one or more advertisements to include in the email message according to one or more user parameters. Identifying advertisements can include identifying a specific advertisement selected by the user or one selected according to user specified criteria. In some implementations, one or more advertisements are automatically identified according to user inputted content, including the content of the email composed, or predefined criteria. Alternatively, in some implementations, the system does not identify advertisements unless requested. For example, the email interface can include a button for identifying advertisements to include in the current email message (e.g., a “suggest advertisements” button within the email interface). Identifying one or more advertisements will be described in greater detail below.

The system inserts or otherwise associates 408 the identified one or more advertisements into/with the email message. In some implementations, the advertisement is inserted into a signature block of the email message. The signature block is a region, for example, at the bottom of an email message following user inputted content (e.g., message text). In some implementations, the inserted one or more advertisements are not visible to the sending user prior to sending the message (e.g., the advertisement is not rendered in the composition field of the email message as seen by the user).

The system sends 410 the email message, including the inserted one or more advertisements, to one or more recipients identified by the e-mail message. When a recipient views the email message, the advertisement is presented to the recipient as part of the received email message (e.g., at the bottom of the email message in the sending user's signature block).

FIG. 5 shows an example method 500 for identifying one or more advertisements to include in an email message. For convenience, the method 500 will be described with respect to a system (e.g., email system 102) that performs the method 500. When a new email message has been generated (e.g., as in method 400 above), the system receives 502 a first user input to the email message. In some implementations, the first user input includes receiving an identification of the recipient, subject, and/or body text of the email message. For example, the user can type a message to be sent to a particular recipient and having a particular subject.

In one implementation, the system uses the received input and/or a context of the received input to identify 504 one or more candidate advertisements. For example, for user input including the text of the body or subject of the email message, the context can include one or more key words identified from the text. The system can use key words to identify particular candidate advertisements corresponding to those key words. For example, in one implementation, the email system sends a request for advertisements to an advertising system (e.g., advertising system 106) including the key words. The advertising system then identifies available advertisements matching/associated with those key words and sends the advertisements to the email system. In some implementations, the user can pre-specify a list of categories and/or keywords, which are then used instead of, or in addition to, the contents of the email to identify advertisements.

In one implementation, the system suggests 506 the one or more candidate advertisements to the user. For example, the system can present a list of the candidate advertisements to the user for selection. In some implementations, the list provides a description of the candidate advertisements (e.g., name of company, product, incentive offered, etc.). In other implementations, the list of candidate advertisements includes the actual advertisements so that the user can see the particular advertisements. In some implementations, the list of candidate advertisements includes an option to send the email message without an advertisement.

The system receives 508 a second user input selecting one or more of the candidate advertisements for inclusion in the email message. The user input can include, for example, using a cursor to select a displayed advertisement from the list of candidate advertisements. Alternatively, the user input can include a request for alternative advertisements. The system can replace the list of candidate advertisements with alternative candidate advertisements from which the user can select. The user can request alternative candidate advertisements until a particular advertisement is selected. In some implementations, the system identifies alternative keywords that are then used to identify alternative candidate advertisements. In some implementations, the email system automatically selects one or more advertisements to be included without presenting advertisements to the user for selection.

In an alternative implementation, the system receives a second user input that indicates no advertisement should be included in the email message. For example, the displayed list of candidate advertisements can include a user selectable entry not to include an advertisement (e.g., “don't include advertisements in this email message”).

The selected advertisement can then be included (or not) in the email message and sent to particular recipients, for example, as described above in FIG. 4.

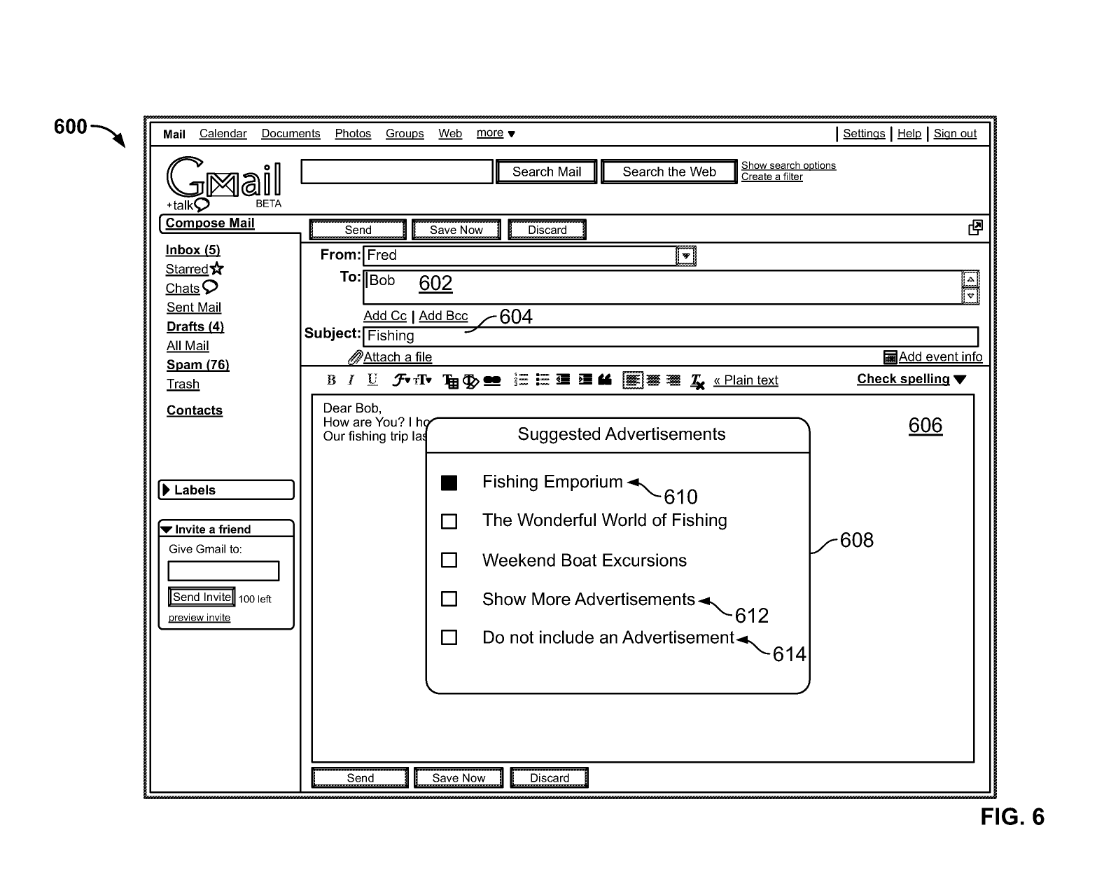

FIG. 6 is an example screenshot of an email composition display 600. The email composition display 600 includes fields identifying the recipients 602, subject 604, and message body 606. A portion of text input into the message body 606 is shown indicating the email message content. A suggested advertisement display 608 lists candidate advertisements for user selection. The candidate advertisements can be identified using the context of the input to the email message composition display 600 as described above. For example, the subject and body of the text refer to “fishing”. Using “fishing” as a keyword, candidate advertisements associated with that key word were identified and displayed. In addition to the candidate advertisements, the suggested advertisement display 608 also includes an option not to include any advertisements 614 in the current email message. Additionally, the suggested advertisement display 608 also includes an option to display more candidate advertisements 612.

The suggested advertisement display 608 shows that the user has selected an advertisement for “Fishing Emporium” 610 from the list of candidate advertisements for inclusion in the email message. In some implementations, following selection of a candidate advertisement, the suggested advertisement display 608 is no longer displayed. The selected advertisement can be inserted into the message body 606, for example, at the bottom of the message body 606. Alternatively, the selected advertisement is not inserted into the email message until it is sent to the designated recipient.

FIG. 7 shows an example method 700 for identifying one or advertisements. For convenience, the method 700 will be described with respect to a system (e.g., email system 102) that performs the method 700. After a new email message has been generated (e.g., as in method 400 above), the system uses 702 one or more specified parameters to select one or more candidate advertisements.

The specified parameters can include user specified settings for providing advertisements within email messages. For example, the user can access one or more settings menus within an email interface in order to specify advertising parameters. The specified parameters can include, for example, parameters identifying the types of advertisements to use, accounting parameters for receiving advertising revenue, and limitations on advertisement recipients.

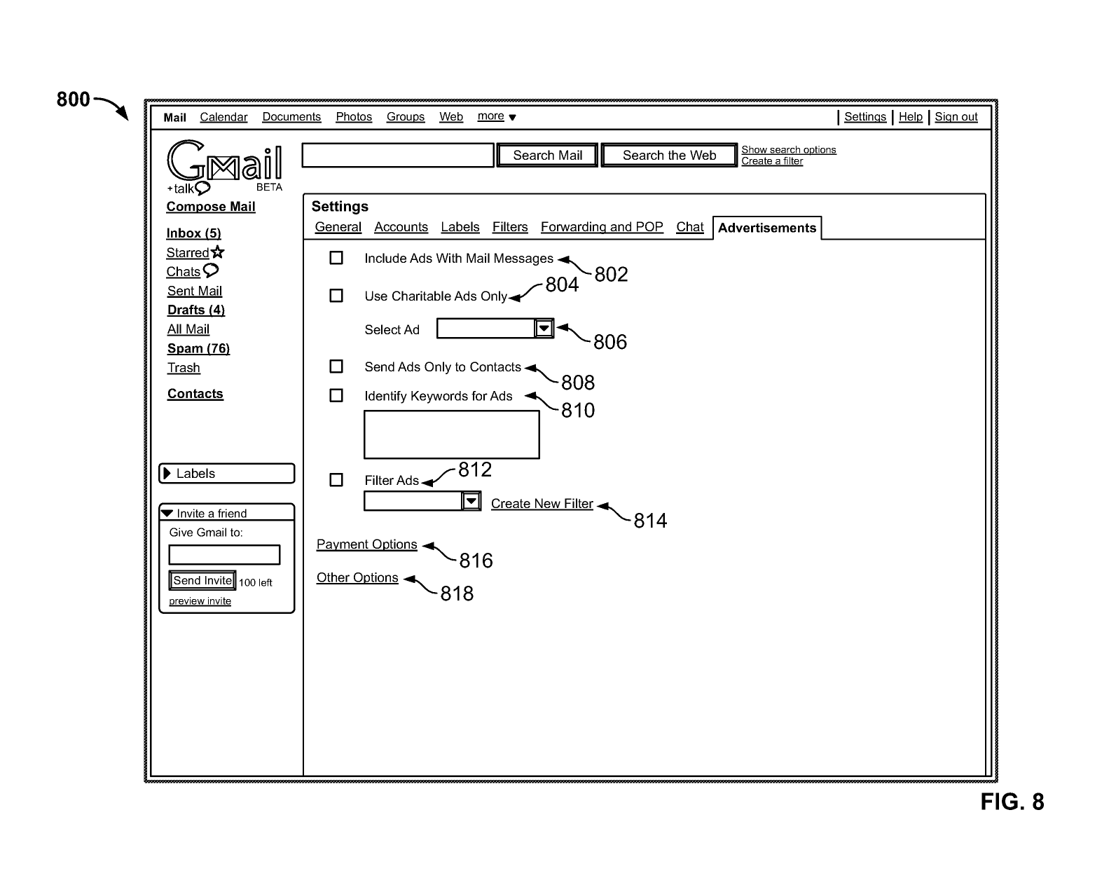

FIG. 8 is an example screenshot of an email settings display 800. The email settings display 800 can be, for example, part of a settings interface in an email display. The email settings display 800 includes an inclusion parameter 802 for including advertisements in email messages. For example, a user can indicate (e.g., using a checkbox) that advertisements should be suggested for inclusion in email messages, or alternatively, included without suggestion. Additionally, the user can indicate that advertisements should not be included in any email messages.

The email setting display 800 also includes a charitable advertisements parameter 804. The charitable advertisements parameter 804 allows the user to indicate that only advertisements associated with charitable organizations should be suggested. In some implementations, advertisements for non-profit organizations can be included in email messages without providing any credit to a user account. Alternatively, when the user does not indicate that charitable advertisements are to be used, the included advertisements can result in advertising revenue to the user's account.

In some implementations, the user can select a charitable advertisement to be used, for example, using a charitable drop down menu 806. For example, the charitable drop down menu 806 can include a list of specific advertisements available for inclusion in the user's email messages. Alternatively, the charitable drop down menu 806 can include categories of charitable organizations from which the user can select. The user can then receive a suggestion of one or more candidate charitable advertisements from that category during email message composition. While reference is made to charitable advertisements, other special types of advertisements of other types can be identified.

The email setting display 800 also includes a recipient parameter 808. The recipient parameter identifies particular recipients that are allowed to receive advertisements with email messages. Consequently, in some implementations, an advertisement can only be suggested to the user or included in an email message when the recipient of the email message is allowed. For example, the user can indicate that only recipients that are in an address book, contacts list, or other set of recipients receive advertisements. In an alternative implementation, the user can specifically identify individual recipients. For example, a user can target specific advertisements for inclusion in email messages to individual recipients. Alternately, the user can specify that advertisements are only sent to specified recipients, for example, to recipients specified in the “To” list, but not to users in the “CC” list etc.

The user can indicate specific keywords to be used in identifying advertisements using a keyword parameter 810. The key word parameter 810 indicates that a user specified set of keywords should be used when identifying advertisements to suggest for inclusion in an email message. The user can specify keywords in an input field, for example, listing desired keywords. The email system can use these keywords instead of content in the email message when identifying advertisements. Thus, the keywords used to identify advertisements can be independent of the particular content of the email message being composed by the user.

A filter parameter 812 allows the user to select one or more filters to be used in identifying advertisements. The email system can provide default filters or the user can create new filters. For example, the email setting display 800 shows a create new filter link 814 which allows the user to create a new filter when selected. The filters can sort the types of advertisements that can be suggested to the user. For example, a “Fortune 500” filter requires that all of the identified advertisements suggested to the user correspond to companies listed in the Fortune 500 index. Other types of filters may include filtering based on the family status of the ad, for example, porn versus family safe advertisements.

Additional parameters can allow the user to specify other options including, for example, accounting options for receiving payment for advertisements. For example, email setting display 800 shows a payment options link 816 and other options link 818. The payment options link 816 can result in a display corresponding to a number of accounting options. The accounting options can specify, for example, how the user is credited for advertisements that are sent in email messages. The other options link 818 can provide a display presenting other options to the user for customizing how advertisements are suggested and to whom the advertisements can be sent. Other parameters can include specifying a minimum bid for advertisements that will be sent in the user's email, or a minimum quality (e.g., as measured by click-through-rate (CTR)) for the advertisements.

The specified parameters are used to identify particular advertisements. For example, the user parameters can indicate that advertisements include particular keywords and only to recipients in the user's contacts list. The email system determines whether or not the recipient in the email message is in the user's contact list. When the recipient is in the user's contact list, the email system then requests advertisements, e.g., from an advertising system. The request can include the specified key words from the user's parameters. The email system receives one or more candidate advertisements from the advertising system that satisfy the user parameters.

As shown in FIG. 7, the system suggests 704 the one or more candidate advertisements to the user. The candidate advertisements can be presented, for example, using a pop-up display in the email composition display. The candidate advertisements can be presented in a similar manner to that described above with respect to FIGS. 5-6. They system can present the candidate advertisements as a selectable list. In some implementations, the list includes options to identify more advertisements or to not include any advertisements in the email message.

The system receives 706 a user input selecting zero or more advertisements from the suggested advertisements. For example, the user can use a cursor to select an individual advertisement to include in the email message. In some implementations, the user can select more than one advertisement to include in a single email message. In other implementations, the user can choose not to include an advertisement in the particular email message. Once the user has provided a selection input, the display of candidate advertisements is no longer shown. In some implementations, the selected advertisement is rendered into the body of the email message (e.g., in the signature block). Alternatively, the selected advertisement is not incorporated into the email message until sent to the designated recipient or recipients.

In some implementations, a user can initiate the use of advertisements in email messages by establishing an account with and advertising system. For example, the user can create an account with the advertising system in order to participate in revenue sharing from including advertisements in email messages. Additionally, in some implementations, the user can identify advertisements to include directly with the advertising system, for example, when creating the account.

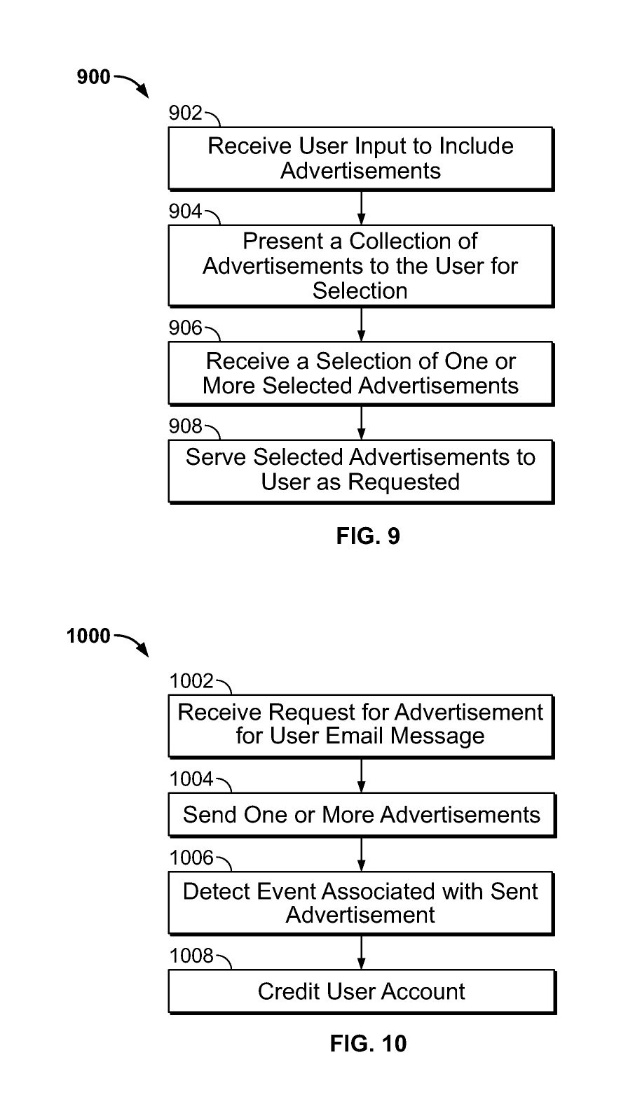

FIG. 9 shows an example method 900 for providing advertisements. The advertisements can be provided, for example, from an advertising system to an email system for inclusion in email messages. For convenience, the method 900 will be described with respect to a system (e.g., advertising system 106) that performs the method 900.

The system receives 902 a request to include advertisements. The request to include advertisements can be part of a user creation of an account with the advertising system. For example, the user can access a web page associated with the advertising system or a particular advertiser. The user can request to include advertisements in email messages and provide account information (e.g., username, password, banking information, email account information) in order to establish the account.

The system presents 904 a collection of advertisements to the user for selection. In some implementations, the advertising system allows the user to search, sort, or otherwise navigate a collection of available advertisements. For example, the user can input key words to search for particular advertisements corresponding to those keywords. In another example, the user can navigate the collection of advertisements, for example, by identifying categories or subcategories of advertisements such that the advertising system presents advertisements matching that category or subcategory.

In some implementations, the user can view advertisements as they will be presented to recipients. Alternatively, the user is provided with a description of each advertisement. In some implementations for advertisements having dynamic content, the user is presented with a static view of the advertisement.

In other implementations, the user provides input indicating interests and other demographic information when setting up their advertising account. The system can use this information to identify and present advertisements associated with that information. For example, if the user indicates that they wish to include advertisements related to automobiles, the system can present a collection of advertisements related to automobiles.

The system receives 906 a selection of one or more advertisements. In some implementations, the user can select a particular advertisement to be included in all email messages. Alternatively, the user can select several advertisements to be including in email messages according to specified criteria. For example, the user can select several advertisements that are inserted at random or according to a specified pattern into the user's email messages. In another example, the user can classify the selected advertisements such that particular advertisements will be inserted in email to particular recipients. Thus, a particular advertisement can be sent to particular recipients while a different advertisement can be sent to one or more other recipients. Consequently, the advertisements can be selected according to the potential interest of the advertisement to those recipients (e.g., as determined by the user). In some implementations, the user can designate the recipients within the advertising system. Alternatively, the user can designate the recipients within the email system.

The system serves 918 selected advertisements to the user as requested. In some implementations, the system sends the selected advertisements to the email system so that they are available whenever the user sends email messages. Alternatively, the system waits to receive a request for an advertisement from the email system (e.g., when the user composes an email message). When a request is received, the system serves the selected advertisement according to any user criteria. For example, if the user classified selected advertisements based on recipient, the request from the email system can identify the recipient. The system can then identify the corresponding advertisement to provide to the email system.

In some implementations, advertisements are provided by the advertising system to the email system in response to individual requests for an advertisement to be included in a particular email message. FIG. 10 shows an example method 1000 for providing advertisements to an email system. For convenience, the method 1000 will be described with respect to a system (e.g., advertising system 200) that performs the method 1000.

The system receives 1002 a request for one or more advertisements to be included in a user's email message. The request can be received, for example, from an email system in response to a user composition of a new email message. In some implementations, the system can first provide a list of suggested advertisement for user selection. The suggested advertisements and the particular requested advertisements can satisfy specified user parameters (e.g., type of advertisement, recipient of advertisement). In some alternative implementations, the system automatically selects one or more advertisements in response to the request for an advertisement. For example, the advertising system can identify candidate advertisements and automatically select one or more (e.g., according to a ranking) for inclusion without receiving a user selection.

The system sends 1004 one or more advertisements to the email system for inclusion in the email message. The advertisements sent can, for example, correspond to the specified user parameters, correspond to one or more advertisements selected by the user, or correspond to one or more advertisements selected by the advertising system.

In some implementations, the system tags the advertisements with an identifier that identifies the user sending the email message that includes the advertisement. The user can be identified, for example, by the user's account number or other unique data.

The system detects 1006 an event associated with the sent advertisement. The detected event can include an impression or conversion associated with the advertisement. For example, the recipient that receives an email message that includes the advertisement can select the advertisement (e.g., by clicking on the advertisement within the body of the email message). Selecting the advertisement can initiate a browser session that points to a particular network location corresponding to the advertisement. For example, the network location can provide more information associated with the advertisement or one or more incentives (e.g., purchase discounts). When the user views the additional information at the network location, the system can detect an impression event as having occurred. If the recipient purchases an item associated with the advisements, the system can detect a conversion event as having occurred.

The system credits 1008 the user's account when a particular event is detected. For example, the user can receive credit for each advertisement impression. When an impression is detected from an advertisement associated with the user, the user's account is appropriately credited. For example, if a particular advertiser pays the advertising system $0.02 for each impression, the advertising system can split this with the user providing the advertisement (e.g., $0.01 each).

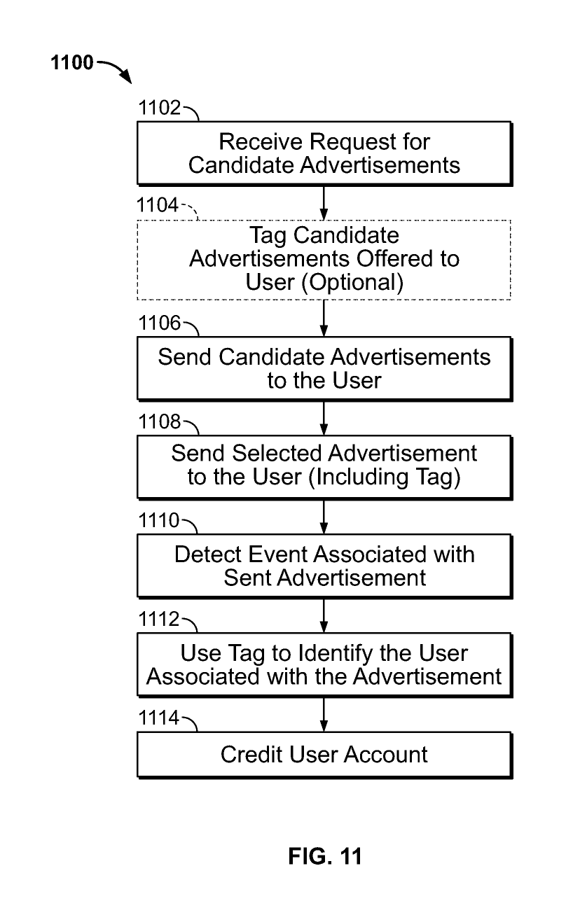

In order to identify the user associated with a given advertisement event, the advertising system tracks the advertisement. FIG. 11 shows an example method 1100 for tracking email advertisements. For convenience, the method 1100 will be described with respect to a system (e.g., advertising system 200) that performs the method 1100.

The system receives 1102 a request for candidate advertisements. The candidate advertisements are advertisements to be suggested to a user for inclusion in an email message. The request can include selection parameters specified by the user (e.g., keywords based on message text or specified keywords, filters, recipient classes, etc.). The system can also identify candidate advertisements using parameters associated with individual advertisements (e.g., geographic location restrictions, time restrictions, keyword restrictions, etc.). Alternatively, the system can automatically select advertisements for the user.

The system optionally tags 1104 identified candidate advertisements to be offered to the user. The tag identifies the particular user, uniquely linking the user to the advertisements. The system sends 1106 the candidate advertisements to the email system. For example, a list describing each of the candidate advertisements can be sent to the email system for display to the user. The user can then select a particular candidate advertisement to be included in the email message. In an alternative implementation, each of the advertisements, along with the corresponding tag, are sent to the email system. As a result, once the user selects an advertisement from the candidate advertisements, the advertisement does not need to be retrieved from the advertising system.

The system sends 1108 the selected advertisement to the user. The system receives an identification of which candidate advertisement the user has selected and sends that advertisement to the email system of the user. In some implementations where the advertisement has not yet been tagged, the system tags the advertisement before sending the advertisement. As a result, the user can send an email message that includes the selected advertisement including the tag identifying the user.

The system detects 1110 an event associated with the selected advertisement. For example, the user sends the email message including the advertisement to a recipient. The recipient selects the advertisement displayed in the email message. In some implementations, selecting the advertisement (e.g., by clicking on the advertisement) opens a browser connection to a particular location associated with the advertisement. The act of viewing advertising information at the network location can trigger an impression event. Alternatively, the user can perform a transaction as a result of viewing the advertisement (e.g., makes a purchase) triggering a conversion event.

Whether an impression or conversion event is triggered can depend on the parameters associated with the advertisement in the advertising system. For example, an advertiser can designate that it will only pay for conversion events. Alternatively, the advertiser can have separate payment scales between conversion events and impression events.

In an alternative implementation, the advertisement includes an incentive (e.g., a discount) and can be physically printed and used, for example, in a physical store. The advertisement can be printed with a tag represented as a visible code identifying the user. When the user purchases an item using the advertisement (a conversion event), the advertisement is collected. The collected advertisement is returned to the advertising system, which then registers the occurrence of an event associated with the advertisement.

When an event is registered by the advertising system, the system uses 1112 the tag attached to the advertisement to identify the user associated with the advertisement. For example the tag can include a code that uniquely identifies the particular user. The system uses the code to identify the user. Additionally, the system can determine if the advertisement is still valid. For example, the advertisement can have an expiration period. If the even occurs after the expiration period, the adverting event can be discarded.

If the advertisement is valid, the system credits 1114 the user's account. The user's account is credited according to the sharing between the particular sharing between the user and the advertising system and the amount the advertiser has agreed to pay for the event.

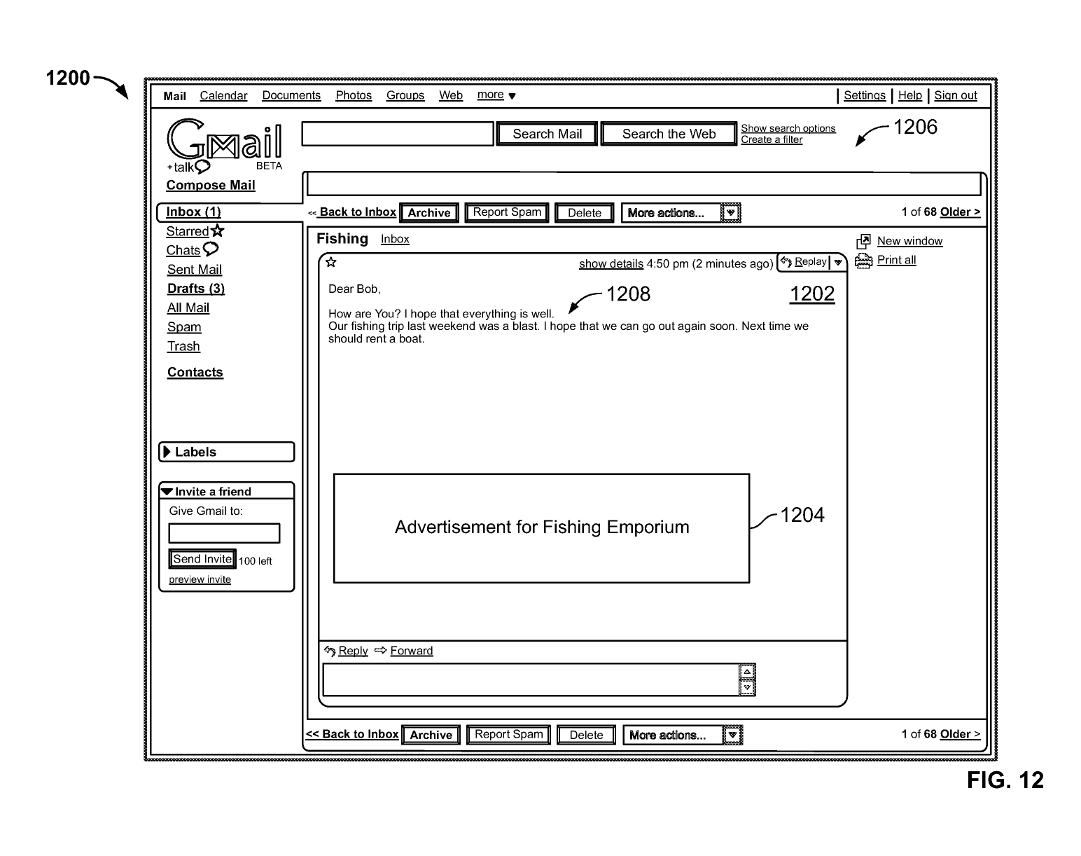

FIG. 12 is an example screenshot 1200 of a received email 1202 including an advertisement 1204. The screenshot 1200 shows an email interface 120 where the recipient is viewing the received email 1202. The received email includes body text 1208 providing the message content and the advertisement 1204. The recipient can select the advertisement 1204, possibly leading to an advertisement event being triggered. The advertisement 1204 is positioned, for example, at the bottom of the email message (e.g., in a signature block). However, in other implementations, the advertisement can be positioned in different locations within the email body. The advertisement 1204 can be in the form of text, an image, or dynamic content (e.g., audio/video content).

Alternatively, the advertisement 1204 can simply be provided as a link which the user can select in order to be directed to the advertisement. Additionally, if the advertisement 1204 is meant to be printed, the advertisement 1204 can include additional information including a code identifying the user, redemption information, and machine readable data (e.g., a bar code).

In some alternative implementations, advertisements can be added to other applications instead of or in addition to email. For example, one or more advertisements can be added to messages sent using a messaging system (e.g., as part of an instant messaging application or messaging within a social network). For example, an outgoing message can include an advertisement following the user's text. When received by the messaging recipient, the body of the message can be accompanied by an advertisement within the messaging window (e.g., following message text). The advertisement can be selected and incorporated in a similar manner as described above with respect to advertisements included with email messages. For example, the advertisement can be selected according to one or more parameters (e.g., user preferences) or based on keywords or other content of the message. Additionally, as described above, one or more advertisements can be suggested to users for inclusion in messages.

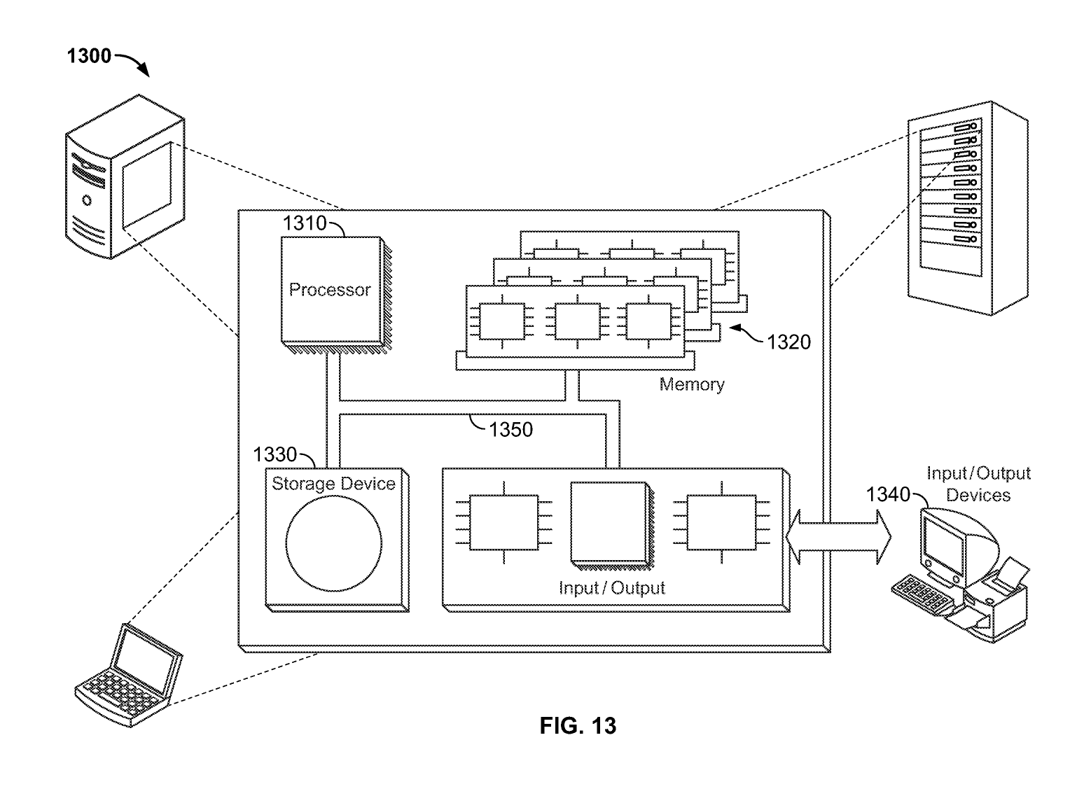

FIG. 13 is a schematic diagram of a generic computer system 1300. The system 1300 can be used for practicing operations described in association with the methods shown above. The system 1300 can include a processor 1310, a memory 1320, a storage device 330, and input/output devices 1340. Each of the components 1310, 1320, 1330, and 1340 are interconnected using a system bus 1350. The processor 1310 is capable of processing instructions for execution within the system 3100. Such executed instructions can implement one or more components of system 1300, for example. In one implementation, the processor 1310 is a single-threaded processor. In another implementation, the processor 1310 is a multi-threaded processor. The processor 1310 is capable of processing instructions stored in the memory 1320 or on the storage device 1330 to display graphical information for a user interface on the input/output device 1340.

The memory 1320 is a computer readable medium such as volatile or non volatile that stores information within the system 1300. The storage device 1330 is capable of providing persistent storage for the system 1300. The storage device 1330 may be a floppy disk device, a hard disk device, an optical disk device, or a tape device, or other suitable persistent storage means. The input/output device 1340 provides input/output operations for the system 1300. In one implementation, the input/output device 1340 includes a keyboard and/or pointing device. In another implementation, the input/output device 1340 includes a display unit for displaying graphical user interfaces.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer-readable medium. The propagated signal is an artificially generated signal, e.g., a machine-generated electrical, optical, or electromagnetic signal, that is generated to encode information for transmission to suitable receiver apparatus for execution by a computer. The computer-readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
generating an email message;
receiving content for the email message from a user;
analyzing the received content of the email message to identify one or more key words;
identifying, by a mail server of an email system, based on analyzing the content of the email message, a plurality of candidate content items associated with the one or more key words;
suggesting, by the mail server, the plurality of candidate content items to the user;
receiving a user input selecting one or more content items of the plurality of candidate content items, wherein the selected one or more content items are included in the email message; and
sending, by the mail server, the email message from the user to an intended recipient identified by the email message, the email message including the one or more selected content items.

2. The method of claim 1, where identifying the plurality of candidate content items further comprises:
identifying advertisements according to one or more user specified parameters.

3. The method of claim 2, where the user specified parameters include a designation of advertisements shown for free.

4. The method of claim 2, where the user specified parameters include specified keywords to be used for advertisement selection.

5. The method of claim 2, where the user specified parameters include an identification of recipients to receive advertisements from the user.

6. The method of claim 2, where the specified parameters include one or more filters and identifying the plurality of candidate content items includes applying the one or more filters to a collection of advertisements.

7. (canceled)

8. The method of claim 1, where suggesting the plurality of candidate content items includes presenting one or more advertisements to the user.

9. The method of claim 1, where receiving the user input comprises receiving a selection of a particular advertisement of the selected content items.

10. The method of claim 1, where receiving the user input comprises receiving an input to not include an advertisement with the email message.

11. A method comprising:
receiving a request from a user for one or more content items to be included in a message, the one or more content items satisfying one or more parameters;
identifying one or more content items according to the one or more parameters; and
sending the one or more content items the user.

12. The method of claim 11, where receiving a request includes receiving the one or more parameters.

13. The method of claim 11, where receiving the one or more parameters includes receiving one or more keywords of the message.

14. The method of claim 11, where identifying one or more content items comprises sorting a collection of available advertisements according to the one or more parameters.

15. The method of claim 11, further comprising:
tagging the one or more content items prior to sending the one or more content items to the user;
identifying an event associated with particular content items;
using the tag associated with the content items to identify the user; and
crediting an account of the user.

16. The method of claim 15, where the event is an impression or click event by a recipient of the message.

17. The method of claim 15, where the event is a conversion event by a recipient of the message.

18. A method comprising:
receiving an input from a message system user to include content items in messages;
present a collection of content items for selection according to user specified criteria;
receive a selection of one or more selected content items from the collection; and
serving the selected content items to the message system.

19. The method of claim 18, further comprising:
receiving a user input identifying one or more parameters to be used as criteria for presenting a collection of content items for selection.

20. The method of claim 19, where receiving user input identifying one or more parameters includes a type of content item.

21. The method of claim 18, further comprising:
generating an account for the user, the account including information for content item revenue sharing.

22. A method comprising:
identifying one or more identified content items to suggest to a user;
tagging the identified content items, the tag identifying the user associated with the content items;
detecting an event corresponding to a particular content item of the one or more content items;
using the tag associated with the particular content item to identify the user; and
crediting the user according to the detected event.

23. The method of claim 22, where tagging the identified content items includes adding data to each of the content items that uniquely identifies the user.

24. The method of claim 22, where the detected event is an impression or click event.

25. The method of claim 22, where the detected event is a conversion event.

26. A system comprising:
a memory and one or more processors operable to perform operations including:
generating an email message;
receiving content for the email message from a user;
analyzing the received content of the email message to identify one or more key words;
identifying, by a mail server of an email system, based on analyzing the content of the email message, a plurality of candidate content items associated with the one or more key words;
suggesting, by the mail server, the plurality of candidate content items to the user;
receiving a user input selecting one or more content items of the plurality of candidate content items, wherein the selected one or more content items; and
sending, the email message from the user to one or more intended recipients identified by the email message, the email message including the one or more selected content items.

27. The system of claim 26, where identifying the plurality of candidate content items further comprises:
identifying advertisements according to one or more user specified parameters.

28. The system of claim 27, where the user specified parameters include a designation of advertisements shown for free.

29. The system of claim 27, where the user specified parameters include specified keywords to be used for advertisement selection.

30. The system of claim 27, where the user specified parameters include an identification of recipients to receive advertisements from the user.

31. The system of claim 27, where the specified parameters include one or more filters and identifying the plurality of candidate content items includes applying the one or more filters to a collection of advertisements.

32. (canceled)

33. The system of claim 26, where suggesting the plurality of the candidate content items includes presenting one or more advertisements to the user.

34. The system of claim 26, where receiving the user input comprises receiving a selection of a particular advertisement of the selected content items.

35. The system of claim 26, where receiving the user input comprises receiving an input to not include an advertisement with the email message.

36. A system comprising:
a memory and one or more processors operable to perform operations including:
receiving a request from a user for one or more content items to be included in an message, the one or more content items satisfying one or more parameters;
identifying one or more content items according to the one or more parameters; and
sending the one or more content items the user.

37. The system of claim 36, where receiving a request includes receiving the one or more parameters.

38. The system of claim 36, where receiving the one or more parameters includes receiving one or more keywords of the message.

39. The system of claim 36, where identifying one or more content items comprises sorting a collection of available advertisements according to the one or more parameters.

40. The system of claim 36, the system further operable to perform operations including:
tagging the one or more content items prior to sending the one or more content items to the user;
identifying an event associated with particular content items;
using the tag associated with the content items to identify the user; and
crediting an account of the user.

41. The system of claim 40, where the event is an impression or click event by a recipient of the message.

42. The system of claim 40, where the event is a conversion event by a recipient of the message.

43. A system comprising:
a memory and one or more processors operable to perform operations including:
receiving an input from a message system user to include content items in messages;
present a collection of content items for selection according to user specified criteria;
receive a selection of one or more selected content items from the collection; and
serving the selected content items to the message system.

44. The system of claim 43, the system further operable to perform operations including:
receiving a user input identifying one or more parameters to be used as criteria for presenting a collection of content items for selection.

45. The system of claim 44, where receiving user input identifying one or more parameters includes a type of content item.

46. The system of claim 43, the system further operable to perform operations including:
generating an account for the user, the account including information for content item revenue sharing.

47. A system comprising:
a memory and one or more processors operable to perform operations including:
identifying one or more identified content items to suggest to a user;
tagging the identified content items, the tag identifying the user associated with the content items;
detecting an event corresponding to a particular content item of the one or more content items;
using the tag associated with the particular content item to identify the user; and
crediting the user according to the detected event.

48. The system of claim 47, where tagging the identified content items includes adding data to each of the content items that uniquely identifies the user.

49. The system of claim 47, where the detected event is an impression or click event.

50. The system of claim 47, where the detected event is a conversion event.
